(19) United States
(12) Patent Application Publication
(10) Pub. No.: US 2002/0184256 A1
(43) Pub. Date: Dec. 5, 2002

(54) Single-use document address method and system for online document delivery

(76) Inventors: Lainye Reich, Vancouver, WA (US); David M. Hall, Camas, WA (US)

Correspondence Address: HEWLETT-PACKARD COMPANY, Intellectual Property Administration, P.O. Box 272400, Fort Collins, CO, 80527-2400, US

(21) Appl. No.: 09/873,534

(22) Filed: Jun. 4, 2001

(51) Int. Cl. G06F 17/00

(52) U.S. Cl. 707/500

(57) ABSTRACT

A method and system for a computer to deliver an electronic document to an Internet appliance by implementing a single-use document address are provided. A request is made by a wired or wireless device to a remote computer for a document. The remote computer, upon retrieving the document, dynamically assigns a single-use document address to the requested document so that the document is visible on the Internet. The remote computer then sends a message to the wired or wireless device containing the document address for the requested document. The wired or wireless device may then download the document itself if it has Internet connection capabilities and access or it may communicate the document address to an Internet appliance that does have Internet connection capability. The Internet appliance downloads the document by the single-use document address, which is thereafter deleted by the remote computer thereby making the document no longer visible on the Internet. The Internet appliance, after downloading the document, may manipulate and/or generate a hard copy of the document as needed.

### TECHNICAL FIELD

The invention is generally related to computers and, more particularly, to a method and system for dynamically assigning a single-use document address for online document delivery.

### BACKGROUND OF THE INVENTION

The growth of the Internet has made more and more information instantly available to any and all users of the Internet. Practically any user with an Internet browser can search and navigate the Internet to access and retrieve files and documents from anywhere in the world. In order for a file or document to be accessed on the Internet it must have a uniform resource locator (URL) address to locate and access a document or other resource on the Internet. The LRL specifies the protocol to be used in accessing the document or resource (such as http: for a world wide web page or ftp: for a FTP (file transfer protocol) site), the name of the server on which the resource resides, and the path to the resource. Thus, by typing or navigating by the LRL, a user is able to navigate to a website and download any file or document in the world that is accessible on the Internet.

An inherent problem with the Internet, however, is security. Individuals and companies place a large amount of content on the Internet, but the downside to making content available on the Internet means that practically anyone can read it. Thus, sensitive documents that may be confidential, proprietary, or otherwise private must either be somehow securely placed on the Internet with limited access or not be Internet accessible at all. Authentication and encryption techniques can make documents available on the Internet with limited degrees of security. However, hackers and other unauthorized users continually search for new ways to decode and penetrate authentication and encryption barriers, thereby requiring continually heightened levels of security. Because of this ongoing security proliferation and the high costs involved in protecting secure Internet-accessible documents, many Internet users opt to remove sensitive documents from the Internet. However, these documents are then accessible only at the location at which they are stored.

In making documents inaccessible from the Internet, such documents are essentially unavailable to authorized and unauthorized users alike. In an attempt to overcome this problem and allow certain remote users to retrieve certain documents, one solution is to manually post a document to a web server prior to the anticipated use. For example, when a secure document is needed for remote access, a user may take a document that previously is not Internet accessible, manually assign or create a URL for the document, and make the document available on the Internet. However, in doing this, the document becomes publicly visible and subject to access by unwanted users. In addition, the owner of the document is required to know ahead of time which documents are needed for access on the Internet. This is equivalent to a person having to put all the documents that the person may need in a briefcase before a business trip. However, one might forget a critical document or discover that there are additional documents needed. Unless the documents are physically carried on the trip, or a URL is manually assigned to the required documents prior to leaving for the trip, the documents are otherwise unavailable. Consequently, there is a need for a method and system that allows, on an as needed basis, access to documents via the Iternet that may not otherwise be available on the Internet and then removing them from the Internet once they are no longer needed.

Another solution to the remote retrieval problem is to pre-copy documents to a third party secure server and then access the documents on the Internet from the secure server. However, this still does not solve the problem of being able to make documents available on the Internet after the fact when such need may arise. The traveling user cannot, in this case, retrieve the document that is stored at the web server in the user's home city to the third party secure server. Moreover, a user will likely not always have the forethought to send a document to the secure server, or as described above, will realize the need only when sending the document to the secure server is not possible. Therefore, as stated above, a need exists for being able to make a document Internet accessible on an as needed basis, access and/or retrieve it, and remove it from the Internet once the need has expired. Moreover, there is a need for users to access remote documents by mobile devices to make them available for printing, slide presentations and other uses that may not be known ahead of their anticipated time of use.

### SUMMARY OF THE INVENTION

The invention is a method and system for a computer to deliver an electronic document to an Internet appliance by implementing a single-use document address. Briefly described, in architecture, one embodiment of the system, among others, can be implemented as follows. A wired or wireless device makes a request to a remote computer for a document. The remote computer, upon retrieving the document, dynamically assigns a single-use document address to the requested document so that the document is visible and accessible via the Internet. The remote computer then sends a message to the wired or wireless device containing the document address for the requested document. The wired or wireless device may then download the document itself if it has Internet connection capabilities, or it may communicate the document address to an Internet appliance that has Internet connection capability. The Internet appliance then downloads the document using the single-use document address, which is then deleted by the remote computer, thereby making the document no longer visible on the Internet. The Internet appliance (or the wired or wireless device), after downloading the document, may manipulate or generate a hard copy of the document as needed.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the invention. Moreover, in the drawings, like reference numerals designate corresponding parts throughout the several views.

FIG. 1 is a diagram of the components implemented in the invention for dynamically assigning a single-use document address for online document delivery.

FIG. 2 is a diagram of a general-purpose computer that can implement the single-use document address application in the web server is shown in FIG. 1.

FIG. 3 is a diagram of a wired or wireless device as shown in FIG. 1 that can request and receive a single-use document address from the web server as shown in FIG. 1.

FIG. 4 is a diagram of an Internet appliance as shown in FIG. 1 that can request and receive documents from the web server as shown in FIG. 1 with a singleuse document address.

FIGS. 5 and 6 are flowcharts of the process implemented by the web server's single-use URL application, as shown in FIG. 2, in making a document temporarily available on the Internet.

FIG. 7 is a flowchart of the process implemented by the wired or wireless device's single-use URL application, as shown in FIG. 3, in requesting that a document be made temporarily available on the Internet.

FIG. 8 is a flowchart of the process implemented by the Internet appliance's single-use URL application, as shown in FIG. 4, in retrieving a document temporarily available on the Internet.

### DETAILED DESCRIPTION OF THE PREFERRED EMBODIMENT

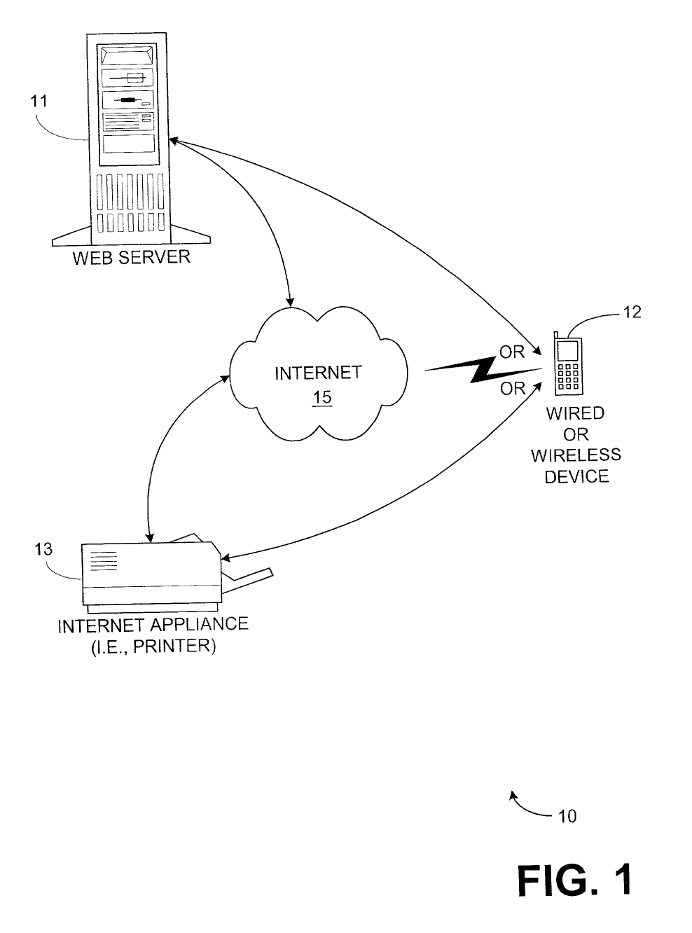

FIG. 1 is a diagram of the components implemented in the system 10 of the invention for dynamically assigning a single-use document address for online document delivery. One embodiment provides that the single-use document address is a uniform resource locator (URL) address. Although this disclosure describes the document address according to a URL addressing embodiment, it should be understood that other document addressing schemes may be employed.

A web server 11 interacts with a wired or wireless device 12 either via the Internet 15 or by other means including, but not limited to, wired or wireless direct telephone connection, infrared communication, etc. The wired or wireless device 12 may be any electronic device capable of communicating with web server 11. Examples of such devices may include, but are not limited to, an analog or digital wireless telephone, a laptop computer with a wired or wireless modem, a desktop computer with wired Internet access (i.e., dial-up modem, cable modem, digital subscriber line (DSL) modem, etc.), or a personal data assistant or other handheld computer with wireless Internet access. The Internet appliance 13 is also capable of independently communicating with the wired or wireless device 12 by means including, but not limited to, a wired or wireless telephone connection, infrared communication, etc.

The single-use URL method and system for online document delivery can be implemented in software (e.g., firmware), hardware, or a combination thereof. In the currently contemplated best mode, the system is implemented in software, as an executable program, and is executed by a special or general purpose digital computer, such as a personal computer (PC; IBM-compatible, Apple-compatible, or otherwise), workstation, minicomputer, or mainframe computer. The web server 11, wired or wireless device 12, and even potentially the Internet appliance 13 contain software to implement the single-use URL application.

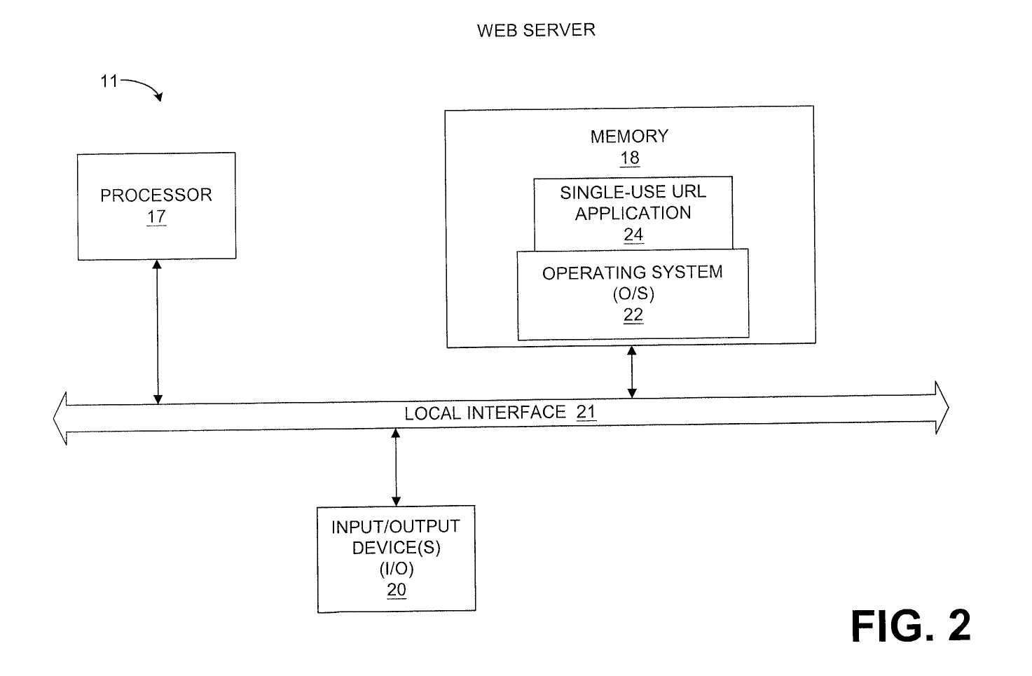

An example of a general-purpose computer that can implement the single-use URL application in the web server 11 is shown in FIG. 2. Generally, in terms of hardware architecture, as shown in FIG. 2, the web server 11 includes a processor 17, memory 14, and one or more input and/or output (I/O) devices 20 (or peripherals) that are communicatively coupled via a local interface 21. The local interface 21 can be, for example but not limited to, one or more buses or other wired or wireless connections, as is known in the art. The local interface 21 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 17 is a hardware device for executing software that can be stored in memory 18. The processor 17 can be any custom made or commercially available processor, a central processing unit (CPU), an auxiliary processor among several processors associated with the web server 11, a semiconductor based microprocessor (in the form of a microchip or chip set), a microprocessor, or generally any device for executing software instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc, or a 68xxx series microprocessor from Motorola Corporation.

The memory 18 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 18 may incorporate electronic, magnetic, optical, and/or other types of storage media. Note that the memory 18 can have a distributed architecture, where various components are situated remote from one another, but can be accessed by the processor 17.

The software in memory 18 may include one or more separate programs, each of which comprises an ordered listing of executable instructions for implementing logical functions. In the example of FIG. 2, the software in the memory 18 includes a suitable operating system (O/S) 22 and the single-use URL application 24. A non-exhaustive list of examples of suitable commercially available operating systems 22 is as follows: a Windows operating system from Microsoft Corporation; a run time operating system from WindRiver Systems, Inc. (i.e., Vxworks); a Macintosh operating system from Apple Computer, Inc.; a NetWare operating system available from Novell, Inc.; an appliance-based operating system such as implemented in handheld computers (i.e., PalmOS, by Palm Computing, Inc., and Windows CE from Microsoft Corporation ); a UNIX operating system, which is available from many ventors, such as Hewlett-Packard Company, Sun Microsystems, Inc., and AT&T Corporation, or a UNIX-type operating system including LINUX, which is freeware available on the Internet. The operating system 22 essentially controls the execution of other computer programs, such as the single-use URL application 24, and provides scheduling, input-output control, file and data management, memory management, and communication control and related services.

The single-use URL system and application 24 is a source program, executable program (object code), script, or any other entity comprising a set of instructions to be performed. When the application 24 a source program, then the program is typically translated via a compiler, assembler, interpreter, or the like, which may or may not be included within the memory 18, so as to operate properly in connection with the O/S 22. Furthermore, the single-use URL application 24 can be written as (a) an object oriented programming language, which has classes of data and methods, or (b) a procedure programming language, which has routines, subroutines, and/or finctions, for example but not limited to, C, C++, Pascal, Basic, Fortran, Cobol, Perl, Java, and Ada.

The I/O devices 20 may include input devices, for example but not limited to, a keyboard, mouse, scanner, microphone, etc. Furthermore, the I/O devices 20 may also include output devices, for example but not limited to, a printer, display, etc. Finally, the I/O devices 20 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

If the web server 11 is a PC, workstation, or the like, the software in the memory 18 may further include a basic input output system (BIOS) (omitted for simplicity). The BIOS is a set of essential software routines that initialize and test hardware at startup, start the O/S 22, and support the transfer of data among the hardware devices. The BIOS is stored in ROM so that the BIOS can be executed when the web server 11 is activated.

When the web server 11 is in operation, the processor 17 is configured to execute software stored within the memory 18, to communicate data to and from the memory 18, and to generally control operations of the web server 11 pursuant to the software. The single-use URL application 24 and the O/S 22, in whole or in part, but typically the latter, are read by the processor 17, perhaps buffered within the processor 17, and then executed.

When the single-use URL application 17 is implemented in software, as is shown in FIG. 2, it should be noted that the single-use URL application 24 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The single-use URL application 24 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the single-use URL application 24 is implemented in hardware, the single-use URL application 24 can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

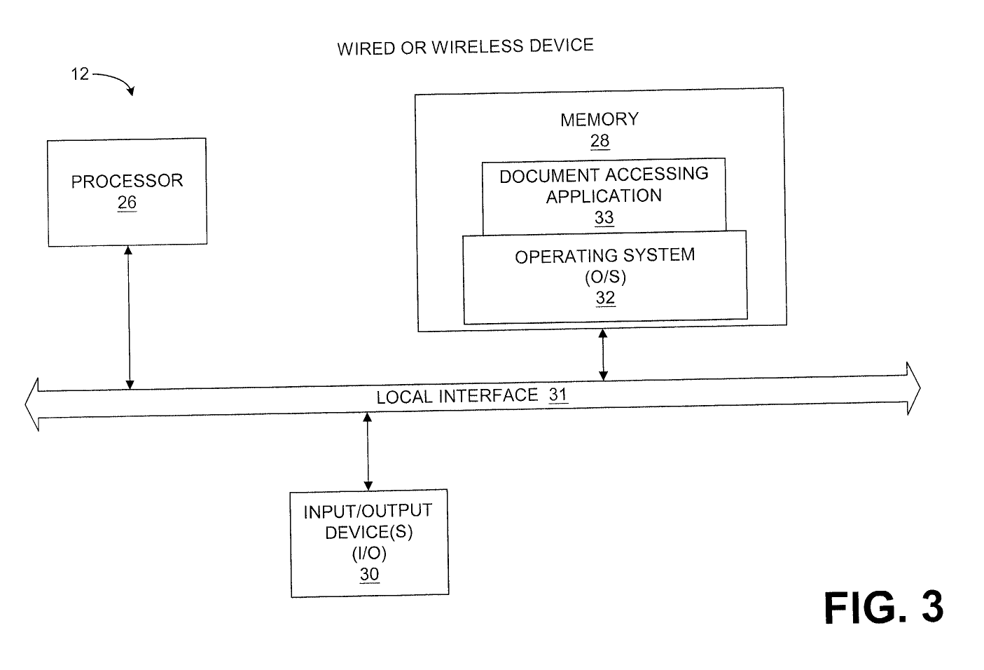

As stated above, the wired or wireless device 12 may be any of a variety of communication devices such as a wireless telephone or a laptop or handheld computer with a wireless modem. One embodiment of the architecture of the wired or wireless device is shown in FIG. 3. Generally, in terms of hardware architecture, as shown in FIG. 3, the wired or wireless device 12, in this embodiment, includes a processor 26, memory 28, and one or more input and/or output (I/O) devices 30 (or peripherals) that are communicatively coupled via a local interface 31. The local interface 31 can be, for example but not limited to, one or more buses or other wired or wireless connections, as is known in the art. The local interface 31 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 26 is a hardware device for executing software that can be stored in memory 28. The processor 26 can be any custom made or commercially available processor, a central processing unit (CPU), an auxiliary processor among several processors associated with the wired or wireless device 12, a semiconductor based microprocessor (in the form of a microchip or chip set), a microprocessor, or generally any device for executing software instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc, or a 68xxx series microprocessor from Motorola Corporation.

The memory 28 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 28 may incorporate electronic, magnetic, optical, and/or other types of storage media. Note that the memory 28 can have a distributed architecture, where various components are situated remote from one another, but can be accessed by the processor 26.

The software in memory 28 may include one or more separate programs, each of which comprises an ordered listing of executable instructions for implementing logical functions. In the example of FIG. 3, the software in the memory 28 includes a suitable operating system (O/S) 32 and a document accessing application 33. A non-exhaustive list of examples of suitable commercially available operating systems 32 is as follows: a Windows operating system from Microsoft Corporation; a run time operating system from WindRiver Systems, Inc. (i.e., Vxworks); a Macintosh operating system from Apple Computer, Inc.; a NetWare operating system available from Novell, Inc.; an appliance-based operating system such as implemented in handheld computers (i.e., PalmOS, by Palm Computing, Inc., and Windows CE from Microsoft Corporation ); a UNIX operating system, which is available from many ventors, such as Hewlett-Packard Company, Sun Microsystems, Inc., and AT&T Corporation, or a UNIX-type operating system including LINUX, which is freeware available on the Internet. The operating system 32 essentially controls the execution of other computer programs, such as the document accessing application 33, and provides scheduling, input-output control, file and data management, memory management, and communication control and related services.

The document accessing application 33 is a source program, executable program (object code), script, or any other entity comprising a set of instructions to be performed. When a source program, then the program needs to be translated via a compiler, assembler, interpreter, or the like, which may or may not be included within the memory 28, so as to operate properly in connection with the O/S 32. Furthermore, the document accessing application 33 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The I/O devices 30 may include input devices, for example but not limited to, a keyboard, mouse, scanner, microphone, etc. Furthermore, the I/O devices 30 may also include output devices, for example but not limited to, a printer, display, a speaker, etc. Finally, the I/O devices 30 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

If the wired or wireless device 12 is a laptop computer, or the like, the software in the memory 28 may further include a basic input output system (BIOS) (omitted for simplicity). The BIOS is a set of essential software routines that initialize and test hardware at startup, start the O/S 32, and support the transfer of data among the hardware devices. The BIOS is stored in ROM so that the BIOS can be executed when the wired or wireless device 12 is activated.

When the wired or wireless device 12 is in operation, the processor 26 is configured to execute software stored within the memory 28, to communicate data to and from the memory 28, and to generally control operations of the wired or wireless device 12 pursuant to the software. The document accessing application 33 and the O/S 32, in whole or in part, but typically the latter, are read by the processor 26, perhaps buffered within the processor 26, and then executed.

When the document accessing application 33 is implemented in software, as is shown in FIG. 3, it should be noted that the document accessing application 33 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The document accessing application 33 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the document accessing application 33 is implemented in hardware, the document accessing application 33 can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

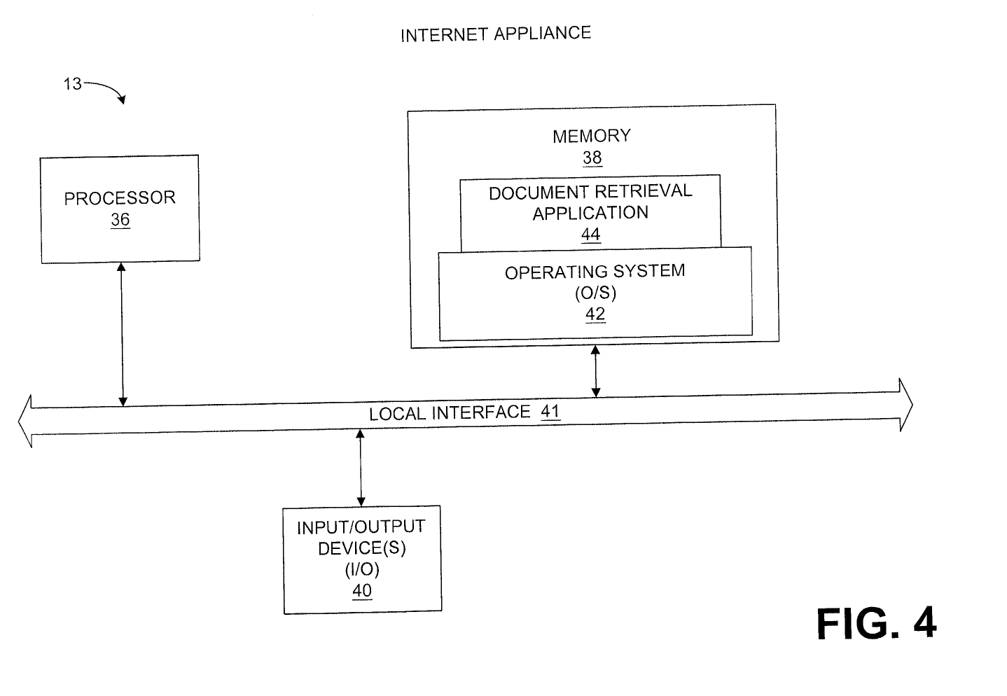

The Internet appliance 13 (FIG. 1) may be, for example, a printer, a video projector, a computer having a CD or DVD ROM with both read/write capabilities, or any other Internet accessible device with Internet connection capabilities. One preferred embodiment of the architecture of the Internet appliance 13 is shown in FIG. 4.

FIG. 4 is a diagram of an Internet appliance 13 as shown in FIG. 1 that can request and receive documents from the web server 11 as shown in FIG. 1 with a single-use URL. Generally, in terms of hardware architecture, as shown in FIG. 4, the Internet appliance 13, in this preferred embodiment, includes a processor 36, memory 38, and one or more input and/or output (I/O) devices 40 (or peripherals) that are communicatively coupled via a local interface 41. The local interface 41 can be, for example but not limited to, one or more buses or other wired or wireless connections, as is known in the art. The local interface 41 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 36 is a hardware device for executing software that can be stored in memory 38. The processor 36 can be any custom made or commercially available processor, a central processing unit (CPU), an auxiliary processor among several processors associated with the Internet appliance 13, a semiconductor based microprocessor (in the form of a microchip or chip set), a microprocessor, or generally any device for executing software instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc, or a 68xxx series microprocessor from Motorola Corporation.

The memory 38 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 38 may incorporate electronic, magnetic, optical, and/or other types of storage media. Note that the memory 38 can have a distributed architecture, where various components are situated remote from one another, but can be accessed by the processor 36.

The software in memory 38 may include one or more separate programs, each of which comprises an ordered listing of executable instructions for implementing logical functions. In the example of FIG. 4, the software in the memory 38 includes a suitable operating system (O/S) 42 and a document retrieval application 44. A non-exhaustive list of examples of suitable commercially available operating systems 42 is as follows: a Windows operating system from Microsoft Corporation; a run time operating system from WindRiver Systems, Inc. (i.e., Vxworks); a Macintosh operating system from Apple Computer, Inc.; a NetWare operating system available from Novell, Inc.; an appliance-based operating system such as implemented in handheld computers (i.e., PalmOS, by Palm Computing, Inc., and Windows CE from Microsoft Corporation ); a UNIX operating system, which is available from many ventors, such as Hewlett-Packard Company, Sun Microsystems, Inc., and AT&T Corporation, or a UNIX-type operating system including LINUX, which is freeware available on the Internet. The operating system 42 essentially controls the execution of other computer programs, such as the document retrieval application 44, and provides scheduling, input-output control, file and data management, memory management, and communication control and related services.

The document retrieval application 44 is a source program, executable program (object code), script, or any other entity comprising a set of instructions to be performed. When a source program, then the program needs to be translated via a compiler, assembler, interpreter, or the like, which may or may not be included within the memory 38, so as to operate properly in connection with the O/S 42. Furthermore, the document retrieval application 44 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The I/O devices 40 may include input devices, for example but not limited to, a keyboard, mouse, scanner, microphone, etc. Furthermore, the I/O devices 40 may also include output devices, for example but not limited to, a printing mechanisms, display, etc. Finally, the I/O devices 40 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

If the Internet appliance 13 is a printer, or the like, the software in the memory 38 may further include a basic input output system (BIOS) (omitted for simplicity). The BIOS is a set of essential software routines that initialize and test hardware at startup, start the O/S 42, and support the transfer of data among the hardware devices. The BIOS is stored in ROM so that the BIOS can be executed when the Internet appliance 13 is activated.

When the Internet appliance 13 is in operation, the processor 36 is configured to execute software stored within the memory 38, to communicate data to and from the memory 38, and to generally control operations of the Internet appliance 13 pursuant to the software. The document retrieval application 44 and the O/S 42, in whole or in part, but typically the latter, are read by the processor 36, perhaps buffered within the processor 36, and then executed.

When the document retrieval application 44 is implemented in software, as is shown in FIG. 4, it should be noted that the document retrieval application 44 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The document retrieval application 44 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the document retrieval application 44 is implemented in hardware, the document retrieval application 44 can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

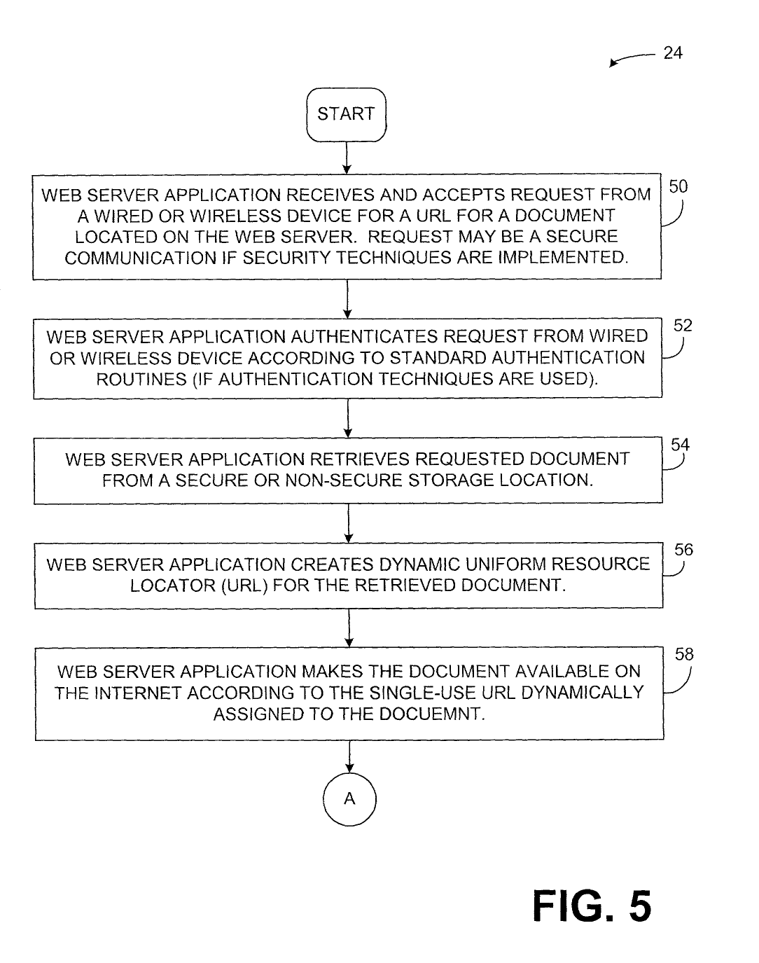

FIG. 5 depicts the process of the single-use URL application 24 on web server 11 for dynamically assigning a single-use URL for making documents available online over the Internet as shown in FIGS. 1 and 2. In step 50, the single-use URL application 24 receives a request from the wired or wireless device 12 described above for a URL for a document located either on a web server 11 or otherwise accessible to the web server 11. The web server 11 may accept requests for documents from the wired or wireless device 12 in any of a variety of methods, including, but not limited to, via the Internet, across a publicly switched telephone network, via infrared communication techniques, and other communication methods. The request from the wired or wireless device 12 may be secure according to standard security techniques.

An optional step 52 provides that the single-use URL application 24 authenticates the request from the wired or wireless device 12 according to standard authentication routines. If the authentication step 52 is employed, it may be implemented by prompting the wired or wireless device 12 for a password to gain access to the web server 11, or it may be significantly more complex depending on the level of security desired.

Once the web server 11 receives the request for the requested document, it seeks to obtain that document, as shown in step 54. The requested document may reside on web server 11, or it may be located remote from the web server 11. In one non-limiting example, the requested document already resides on the web server 11. Thus, the web server 11 easily accesses the document without any intense searching. In another non-limiting example, the web server 11 is able to locate and retrieve any document on the Internet to which the web server 11 has access. In this non-limiting example, if a user, in accessing the web server 11 through a cellular telephone, requests a document that resides on the user's home PC (not shown) rather than the web server 11, the web server 11 may still retrieve the document from the user's home PC if the home PC has an existing Internet connection and the web server 11 has the authority to access the home PC.

In yet another non-limiting example, the web server 11, upon receiving the request for the requested document, retrieves the document from behind a security firewall either local or remote from the web server. Security firewalls are software or hardware protection schemes designed to prevent access to the computer on which the firewall resides. The firewall may allow authorized users to reach documents behind the firewall on the network while denying access to all unauthorized users. A firewall prevents computers in a network from communicating directly with computers external to the network and vice versa. Instead, all communications are routed through a proxy server outside the network. The proxy server decides whether it is safe to allow a particular message or file to pass through to the network. In this non-limiting example, the web server 11 retrieves documents protected by and located behind the firewall that the user may not otherwise be able to access by other retrieval means. When the requested document is located, whether it resides on the web server 11, another networked PC, or behind a security firewall, it is copied and stored in a storage location on the web server 11 where it will be accessible on the Internet.

In making the retrieved document accessible on the Internet, the single-use URL application 24 creates a dynamic URL for the retrieved document, as shown in step 56. The dynamic URL is randomly generated when the document is retrieved and makes the document visible on the Internet for viewing and retrieval. The single-use URL application 24 gives the requested document at least a first level of security in randomly generating the URL name as the name would not likely be known to an unauthorized user. Once the URL is assigned in step 56, the web server 11 makes a document available according to the dynamically assigned URL, as shown in step 58.

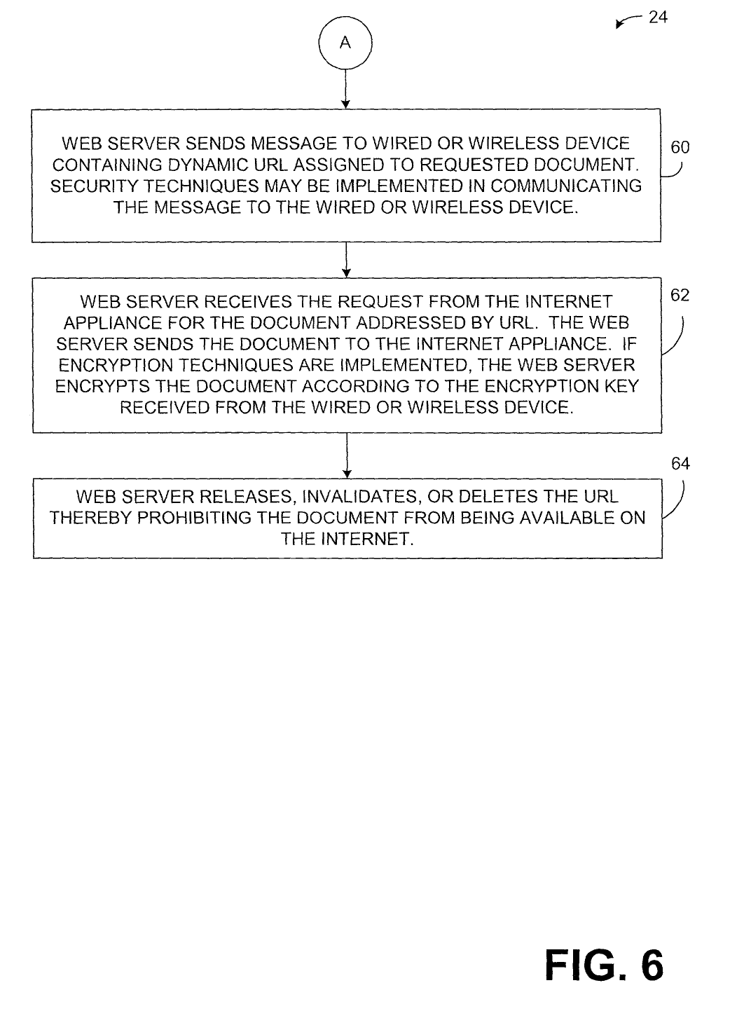

Once the URL is assigned to the retrieved document, the web server's single-use application 24 continues with step 60 (FIG. 6) wherein the web server's single-use URL application 24 sends a message to the wired or wireless device 12 acknowledging that the retrieved document has been assigned a URL. The message to the wired or wireless device 12 contains the dynamically assigned URL. If security techniques are employed, the message, as in step 60, as sent from the web server 11 to the wired or wireless device 12, may be communicated by secure or encrypted techniques to prevent unauthorized access and reception of the message.

After the retrieved document is made available on the Internet according to the single-use URL, the web server 11 may deliver the document to any device with Internet connectivity upon a proper (and potentially authorized) request. As is discussed in further detail below, one embodiment of the invention provides that the Internet appliance 13 requests and downloads the retrieved document from the web server 11 using the single-use URL. If authentication techniques are employed, the Internet appliance 13 may include a password or authentication code with the request for the requested document in addition to the dynamically assigned URL. The web server 11, upon receiving the request from the Internet appliance 13 for the document with the dynamically assigned URL, sends the document to the Internet appliance 13, as shown in step 62. If encryption techniques are used, the web server 11 may encrypt the retrieved document according to an encryption key previously received from the wired or wireless device 12.

As shown in step 64, the web server 11 then releases the URL previously assigned to the requested document thereby making the document no longer available on the Internet. In terminating the URL assigned to the document, the document is no longer visible or downloadable by any user whether authorized or unauthorized. If a copy of the document was made at the web server 11, then this step may also include deletion of the copy of the document from the web server 11. Thus, the dynamically assigned URL is a single-use URL because the web server 11 eliminates or terminates the UTRL assigned to the requested document immediately after the document is requested and downloaded by either the Internet appliance 13 or, as described in the alternative embodiment below, the wired or wireless device 12. This ensures that secure or sensitive documents are made available on the Internet for a limited time thereby reducing any security exposure.

The web server 11 may also, in an alternative embodiment, make the requested document available on the Internet only for a limited time and then remove the document thereafter if not requested by either the Internet appliance 13 or the wired or wireless device 12. If, for some reason, the Internet appliance 13 or the wired or wireless device 12 fails to initiate the request for the document with the dynamically assigned URL, or if some other error occurs such that the request that the dynamically assigned URL is not made, then the web server 11 may remove the document or terminate the URL such that the document is no longer available. In this instance, a supplemental request for a URL for the document would be made in order to retrieve the document. By making the document available on the Internet for a limited period of time, an additional level of security is provided for the requested document in an attempt to prevent unauthorized access by authorized users.

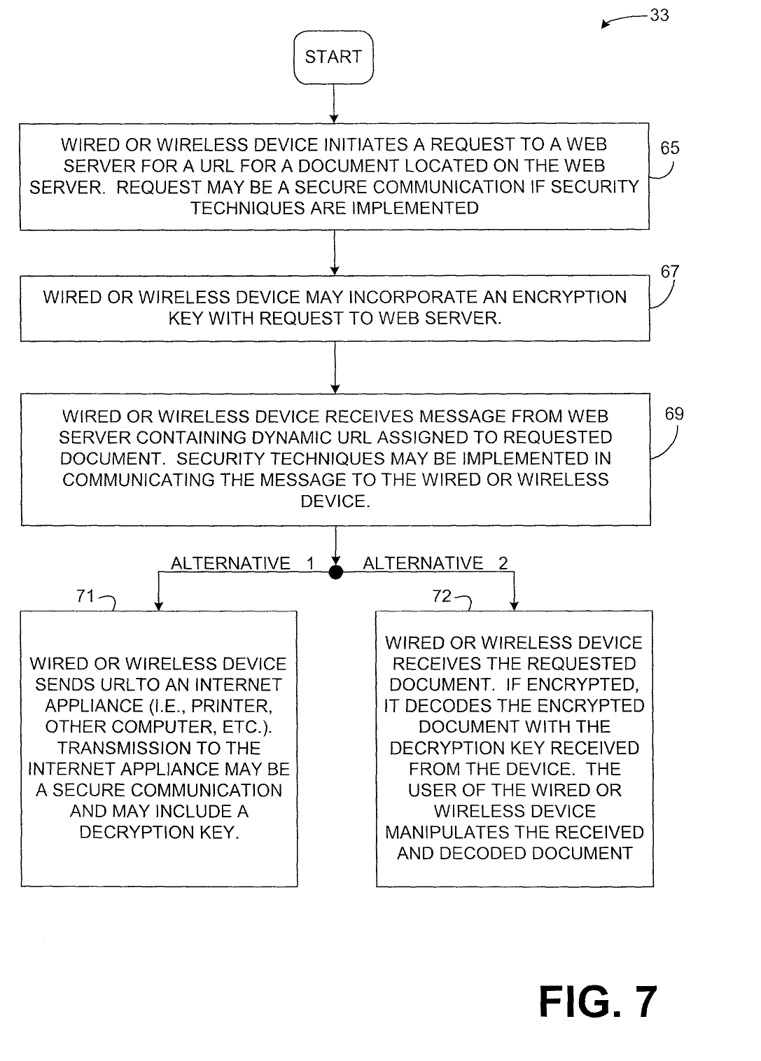

FIG. 7 is a flowchart of the process implemented by the wired or wireless device's document accessing application 33, as shown in FIG. 3, in requesting that a document be made temporarily available on the Internet. The wired or wireless device's document accessing application 33 initiates a request to the web server 11, as in step 65, for a URL for a document located either on a web server or otherwise accessible to the web server 11.

Depending upon the type of wired or wireless device 12, the request for the URL may be made by several methods. As a non-limiting example, if device 12 is a wireless telephone, the request for the URL may be made via the keypad on the wireless telephone that is in communication with web server 11. In this non-limiting example, web server 11 (FIG. 2) may receive telephone calls from the wireless telephone device 12 if equipped with a suitable input/output device 20 (FIG. 2). By using the keypad on the telephone, the user can navigate menus and request the name of the document sought. As another non-limiting example, the wired or wireless device 12 may make the URL request with the web server 11 by accessing and navigating the Internet.

In optional step 67, the wired or wireless device 12 may include an encryption key in the request to the web server 11 for the document in the URL. In this optional step, standard encryption techniques may be employed to add security to the delivery of the on-line document. Thus, the wired or wireless device 12 sends an encryption key to web server 11 to encrypt the on-line document and prevent unauthorized users from being able to access and open the document once a URL is assigned to it.

As discussed above, the web server 11 retrieves and makes the requested document available on the Internet according to a dynamically assigned URL. Once the URL is assigned to the retrieved document, the wired or wireless device's document accessing application 33, as shown in step 69, receives a message from the web server 11 acknowledging that the retrieved document has been assigned a URL. The message to the wired or wireless device 12 contains the dynamically assigned URL. Again, if security techniques are employed, the message, as in step 69, as sent from the web server 11 to the wired or wireless device 12, may be communicated by secure or encrypted techniques to prevent unauthorized access and reception of the message.

In step 71, the wired or wireless device 12, after receiving the URL from the web server 11, sends the URL to the Internet appliance 13. The wired or wireless device 12 may transmit the URL to the Internet appliance 13 by a variety of communication techniques including, but not limited to, across the Internet 15, via infrared communication means, via a publicly switched telephone network, via a direct wired connection, etc. The Internet appliance 13 may be any device with Internet connection technology including without limitation a printer, a computer, a facsimile machine, a laptop, etc. The transmission from the wired or wireless device 12 to the Internet appliance 13 may also be made by secure means to prevent unauthorized access or interception of the transmitted message. Standard security measures and procedures may be employed to secure the communication between these devices. Additionally, if encryption techniques are employed and the document has been encrypted, the wired or wireless device 12 also sends a decryption key to the Internet device 13 as a part of the message in step 71.

In an alternative embodiment as shown in step 72, the wired or wireless device 12 may not only request the dynamically assigned URL, but may also, upon receiving the dynamically assigned U RL, download the requested document if the wired or wireless device 12 has such capability. In this alternative embodiment, the wired or wireless device 12 would also have Internet connection capability and would be able to access the document with the dynamically assigned URL in similar fashion as described below for the Internet appliance 13. Thus, in this alternative embodiment, only two components are employed to both dynamically assign the single-use URL, and download the requested documents to achieve the same result as described above.

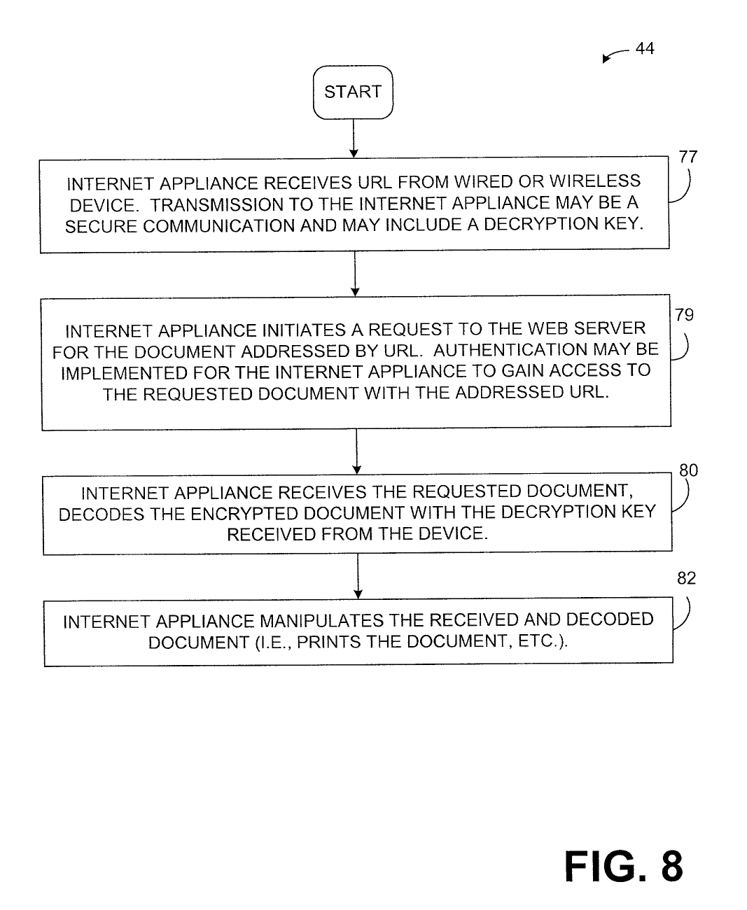

FIG. 8 is a flowchart of the process implemented by the Internet appliance's document retrieval application 44, as shown in FIG. 4, in retrieving a document temporarily available on the Internet. As previously discussed, the wired or wireless device 12 receives the message containing the URL from the web server, as shown in step 69 of FIG. 7, and sends the URL to the Internet appliance 13, as shown in step 71 of FIG. 7. Upon receipt of the communication from the wired or wireless device 12, as in step 77 (FIG. 8), the Internet appliance 13 initiates a request to the web server 11 for the requested document via the dynamically assigned URL, as shown in step 79.

As stated above, the Internet appliance 13 is equipped with Internet connection (HTTP, FTP) capability, so it locates and accesses the URL via standard techniques. If authentication techniques are employed, the Internet appliance 13 may include a password or authentication code with the request for the requested document in addition to the dynamically assigned URL. As discussed above web server 11, upon receiving the request from the Internet appliance 13 for the document with the dynamically assigned URL, sends the document to the Internet appliance 13.

After the Internet appliance 13 access, downloads and receives the document by the dynamically assigned URL, as in step 80, the Internet appliance 13 decodes the document, if previously encrypted, with the key received from the wired or wireless device 12. In this operation, the Internet appliance 13 implements standard Internet connection techniques.

Depending upon the type of device implemented as the Internet appliance 13, several possible actions may result with the document downloaded from the web server 11. As in step 82, the Internet appliance 13 may manipulate the document in a variety of methods. If, as a non-limiting example, the Internet appliance 13 is a printer, then the Internet appliance 13 may simply print the document. As another non-limiting example, the Internet appliance 13 may be a facsimile machine. The document may similarly be accessed and printed much like the previous example. However, if the Internet appliance 13 is a of computer or other PC, then the downloaded document may be displayed by the computer and further edited or manipulated as desired by the user. In this non-limiting example, the user could retrieve and edit a document from the user's home PC if, for example, the user neglected to bring the document on a trip. Moreover, as files and other documents can be corrupted or lost, the invention enables a user to retrieve an original copy from a home PC without regenerating the document from memory or previous incomplete versions.

The flowcharts of FIGS. 5 through 8 show the architecture, functionality, and operation of a possible implementation of the single-use URL method as implemented by the web server, 11, wired or wireless device 12, and Internet appliance 13. In this regard, each block represents a module, segment, or portion of code, which comprises one or more executable instructions for implementing the specified logical function(s). It should also be noted that in some alternative implementations, the functions noted in the blocks might occur out of the order noted in FIGS. 5 through 8. For example, two blocks shown in succession in any of FIGS. 5 and 6 may in fact be executed substantially concurrently or the blocks may sometimes be executed in the reverse order, depending upon the functionality involved, as will be further clarified hereinbelow.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A method for a computer to deliver an electronic document to an Internet appliance, the method comprising the steps of:
receiving a request for a document address for the document;
dynamically assigning a single-use document address to the requested document;
receiving an access request for the document from the Internet appliance via the assigned single-use document address;
sending the requested document to the Internet appliance; and
deleting the single-use document address assigned to the requested document after the requested document has been sent to the Internet appliance.

2. The method of claim 1, further comprising the step of:
granting access to the document according to a password submitted to the computer.

3. The method of claim 1, further comprising the steps of:
receiving an encryption key for encrypting the requested document; and
encrypting the requested document according to the encryption key.

4. The method of claim 1, further comprising the step of:
sending a message from the computer to a requesting source containing the single-use document address assigned to the requested document.

5. The method of claim 1, wherein the computer is an Internet web server computer.

6. The method of claim 1, wherein the document address is a uniform resource locator address.

7. A method for making a document that is stored on a remote server to be accessible on the Internet according to a temporary document address assigned to the document, the method comprising the steps of:
issuing a request to the remote server to retrieve the document and return a temporary document address assigned to the document; and
receiving the temporary document address from the remote server, wherein the document is accessible on the Internet according to the temporary document address assigned to the document; and
communicating the received temporary document address to a remote Internet appliance, wherein the Internet appliance retrieves the document from the remote server according to the received temporary document address.

8. The method of claim 7, further comprising the step of:
communicating authentication information to the remote server to gain access to the remote server.

9. The method of claim 7, further comprising the step of:
communicating an encryption key to the remote server for encrypting the document assigned the temporary document address on the remote server.

10. The method of claim 7, wherein the temporary document address is a uniform resource locator address.

11. A method for making a document available on the Internet according to a dynamically assigned single-use document address, comprising the steps of:
generating a request to a web server for the document from a requesting device;
retrieving the document from a storage location upon receipt of the request;
dynamically assigning a single-use document address to the retrieved document;
sending the single-use document address to the requesting device, wherein the single-use document address is communicated to an Internet appliance;
downloading the retrieved document from the web server according to the single-use document address; and
terminating the single-use document address after downloading the retrieved document.

12. The method of claim 11, further comprising the step of:
communicating the single-use document address to the web server to access the document.

13. The method of claim 11, further comprising the step of:
determining whether the requesting device can access the web server by validating authentication information included in the request.

14. The method of claim 11, further comprising the step of:
encrypting the retrieved document according to encryption information included in the request.

15. The method of claim 14, further comprising the steps of:
communicating a decryption key from the requesting device to the Internet appliance; and
decrypting the retrieved document received from the web server according to the decryption key.

16. The method of claim 11, wherein the single-use document address is a uniform resource locator address.

17. A system to deliver an electronic document to a remote Internet appliance, comprising:
logic configured to receive a request for the document from a requesting source;
logic configured to dynamically assign a single-use document address to the requested document;
logic configured to send the document to the remote Internet appliance upon receipt of a request for the document via the assigned single-use document address; and
logic configured to delete the single-use document address assigned to the requested document after the requested document has been sent to the remote Internet appliance.

18. The system of claim 17, further comprising:
logic configured to grant access to the requesting source by validating a password submitted by the requesting source to the computer.

19. The system of claim 17, further comprising:
logic configured to receive an encryption key from the requesting source; and
logic configured to encrypt the requested document according to the encryption key.

20. The system of claim 17, further comprising:
logic configured to send a message to the requesting source containing the single-use document address assigned to the requested document.

21. The system of claim 17, wherein the single-use document address is a uniform resource locator address.

22. A system for making a document available on the Internet according to a dynamically assigned single-use document address, comprising:
logic configured to generate a request to a web server for the document from a requesting device;
logic configured to implement the web server to retrieve the document from a secure storage location upon receipt of the request;
logic configured to implement the web server to dynamically assign a single-use document address to the retrieved document;
logic configured to implement the web server to send the single-use document address to the requesting device;
logic configured to implement the requesting device to communicate the single-use document address to an Internet appliance;
logic configured to implement the Internet appliance to download the retrieved document from the web server according to the single-use document address; and
logic configured to implement the web server to terminate the singleuse document address after downloading the retrieved document to the Internet appliance.

23. The system of claim 22, further comprising:
logic configured to implement the web server to authenticate the requesting device according to authentication information included in the request.

24. The system of claim 22, further comprising:
logic configured to implement the web server to encrypt the retrieved document according to encryption information included in the request.

25. The system of claim 24, further comprising:
logic configured to implement the requesting device to communicate a decryption key to the Internet appliance; and
logic configured to implement the Internet appliance to decrypt the retrieved document received from the web server.

26. The system of claim 22, wherein the single-use document address is a uniform resource locator address.

27. A system for making a document available on the Internet according to a dynamically assigned single-use document address, comprising:
means for requesting the document;
means for retrieving the document from a secure storage location upon receipt of the request;
means for dynamically assigning a single-use document address to the retrieved document;
means for downloading the retrieved document according to the single9 use document address; and
means for terminating the single-use document address after downloading the retrieved document.

28. The system of claim 27, further comprising:
means for encrypting the retrieved document according to encryption information; and
means for decrypting the retrieved document.

29. A method for an Internet appliance to retrieve a document on the Internet according to a dynamically assigned single-use document address, comprising the steps of:
receiving a single-use document address assigned to the document;
requesting the document from a server computer by the single-use document address;
downloading the document from the server computer upon gaining access to the document with the single-use document address; and
manipulating the document downloaded from the server computer.

30. The method of claim 29, further comprising the step of:
decrypting the downloaded document received from the server computer according to a decryption key.

31. The method of claim 29, wherein the manipulating step further comprises printing the downloaded document.

32. The method of claim 29, wherein the Internet appliance is a video display unit that displays an image of the downloaded document.

33. A system for an Internet appliance to retrieve a document on the Internet according to a dynamically assigned single-use document address, comprising:
logic configured to receive a single-use document address assigned to the document;
logic configured to request the document from a server computer by the single-use document address;
logic configured to download the document from the server computer upon gaining access to the document with the single-use document address; and
logic configured to manipulate the document downloaded from the server computer.

34. The system of claim 33, further comprising:
logic configured to decrypt the downloaded document received from the server computer according to a decryption key.

35. The method of claim 33, wherein said logic configured to manipulate the downloaded document comprises printing the downloaded document.

36. The system of claim 33, wherein the Internet appliance is a video display unit that displays an image of the downloaded document.
